(19) United States
(12) Patent Application Publication
(10) Pub. No.: US 2012/0236379 A1
(43) Pub. Date: Sep. 20, 2012

(54) LADAR USING MEMS SCANNING

(75) Inventors: Mark G. da Silva, Scituate, MA (US); David W. DeRoo, Newport Beach, CA (US); Michael J. Tracy, Mission Viejo, CA (US); Adam Rybaltowski, New Milford, NJ (US); Clark G. Caflisch, Oshkosh, WI (US); Robert M. Potenza, Alameda, CA (US)

(73) Assignee: LightTime, LLC

(21) Appl. No.: 13/216,156

(22) Filed: Aug. 23, 2011

Related U.S. Application Data
(60) Provisional application No. 61/376,223, filed on Aug. 23, 2010.
(60) Provisional application No. 61/435,729, filed on Jan. 24, 2011.

(51) Int. Cl. G02B 26/10

(52) U.S. Cl. 359/200.8; 359/212.2

(57) ABSTRACT

A scanning mirror includes a substrate that is patterned to include a mirror area, a frame around the mirror area, and a base around the frame. A set of actuators operate to rotate the mirror area about a first axis relative to the frame, and a second set of actuators rotate the frame about a second axis relative to the base. The scanning mirror can be fabricated using semiconductor processing techniques or processing methods that do not require clean room process. Drivers for the scanning mirror may employ feedback loops that operate the mirror for triangular motions. Some embodiments of the scanning mirror can be used in a LADAR system for a Natural User Interface of a computing system.

### CROSS-REFERENCE TO RELATED APPLICATIONS

This patent document claims benefit of the earlier filing dates of U.S. provisional Pat. App. Ser. No. 61/376,223, filed Aug. 23, 2010 and U.S. provisional Pat. App. Ser. No. 61/435,729, filed Jan. 24, 2011, which are hereby incorporated by reference in their entirety.

### BACKGROUND

Current scanning LADAR (Laser Detection and Ranging) devices commonly use dual or nodding/rotating galvanometric polygonal mirrors. These traditional mirror systems are relatively expensive, large, and heavy and correspondingly require more power than would a miniature system. Systems and methods for reducing the cost, size, and/or energy consumption of LADAR devices are currently being sought.

### SUMMARY

In accordance with an aspect of the invention, LADAR devices employ microelectromechanical system (MEMS) mirrors that enable use of LADAR in situations where cost, weight, power and form-factor are constrained. Suitable angular ranges and scanning frequencies for a MEMS structure can be achieved using low resistance hinges or flexures with or without angle multiplying optics. Feedback loops that receive input from sensors and generate drive signals for actuators can drive the mirror for triangular motion for both fast and slow axis oscillations. Weighting of the mirror structure and selection of the spring constants of flexures can also provide the mirror with natural or resonance frequencies corresponding to odd multiples of the desired oscillating frequencies to assist in achieving the desired triangular motion. In particular, the mirror can be driven at or near resonant frequencies for efficient energy transfer and large amplitude oscillations while still providing triangular motion.

One embodiment of the invention is a MEMS mirror system. Another embodiment of the invention is a scanning LADAR containing a MEMS mirror system. The MEMS scanning LADAR can provide a real-time 3D image sensor that is compact and lightweight. Image processing and control systems can interface with a LADAR front-end device to post-process output data from the LADAR system for purposes such as image display, analysis, and/or autonomous system control.

In one embodiment, a MEMS mirror can be fabricated without clean-room semiconductor type processes and does not require the development costs of systems manufactured using conventional semiconductor processing. While MEMS mirror configurations can be converted to semiconductor processes for high-volume production, the non-semiconductor mirrors are producible in moderate volumes without costly clean-room processes. The non-semiconductor MEMS mirror can employ piezoelectric actuators such as lead zirconate titanate (PZT) actuators. For the piezoelectric actuator to produce a large angular rotation of a mirror, the PZT or other piezoelectric material can be made thin because part of the resistance to rotation arises from the bulk modulus “stiffness” of the actuator. The substrate supporting the PZT and mirror may also be thin and lightweight to reduce resistance to rotation. Further, hinges can attach the PZT actuators to the mirror to further reduce resistance to rotation. A hinge or flexure can similarly be thin to offer very little resistance to flexing. A hinge can be fabricated in the plane of the supporting substrate (e.g., by patterning the supporting substrate or overlying layers) or provided by a structure that is attached to and extending from the substrate. In one configuration, the actuators attach to the hinges or flexures, and the hinges or flexures transmit force to the mirror from the actuators, causing the mirror to rotate when the actuators move. In another configuration, the actuators attach to the mirror area, so that movement of the actuators rotates the mirror about the hinges or flexures attached to the mirror.

Some further inventive aspects of systems and methods disclosed herein include but are not limited to the following. 1.) The use of closed loop control systems with a MEMS mirror and the proportional-integral-derivative (PID) controllers. Embodiments of closed loop control systems can implement mirror control processes including continuous mirror scan control, as some embodiments of the closed loops control a position waveform with another control signal waveform rather than point by point. 2.) The MEMS mirror structures and fabrication processes can be completed with or without semiconductor processing requiring clean room environments. 3.) Sensors and associated electronics can be integrated into MEMS mirror configurations to measure angles for feedback loop control of the mirror. 4.) MEMS mirror mechanical parameters can include mass distribution and spring constants that provide resonant frequencies that are odd multiples of a scan frequency to facilitate constant angular velocity or triangular motion of the MEMS mirror. 5.) LADAR or MEMS mirror systems can generally contain any combination of the features disclosed herein.

### BRIEF DESCRIPTION OF THE DRAWINGS

FIG. 1A is a block diagram of a LADAR system in accordance with an embodiment of the invention.

FIG. 1B is a perspective view illustrating the scan field of the LADAR system of FIG. 1A.

FIG. 2 shows a connection of actuators to a flexure in a MEMS scanning mirror system in accordance with an embodiment of the invention.

FIGS. 3A and 3B respectively show a plan view and a cross-sectional view of a MEMS scanning mirror system in accordance with an embodiment of the invention having actuators attached to flexures defining a fast scanning axis of the MEMS mirror system.

FIG. 4 shows a plan view of a MEMS scanning mirror system using a hybrid drive approach in which electrostatic forces drive rotations about a fast axis and piezoelectric actuators drive rotations about a slow axis.

FIGS. 5A and 5B respectively show a plan view and a cross-sectional view of a MEMS scanning mirror system in accordance with an embodiment of the invention using a tilt mechanism instead of a flexure for one rotation axis of the mirror.

FIGS. 6A and 6B respectively show a plan view and a cross-sectional view of a MEMS scanning mirror system in accordance with an embodiment of the invention employing a frame suspended by actuators that drive one rotation axis of a mirror.

FIG. 6C illustrates an electrostatic tilt mechanism in accordance with an embodiment of the invention employing inclined electrodes.

FIG. 7 illustrates a MEMS scanning mirror employing straight piezoelectric actuators for one rotation axis and semicircular piezoelectric actuators for another rotation axis.

FIG. 8 shows a plan view of a MEMS scanning mirror in accordance with an embodiment of the present invention having actuators with a non-linear shape or multiple pieces.

FIG. 9A shows an embodiment of a MEMS scanning mirror in which actuators connect to flexures for the fast rotation axis of a mirror.

FIG. 9B shows an embodiment of a MEMS scanning mirror in which hinges connect actuators to a mirror.

FIGS. 9C and 9D respectively show a perspective view and a cross-sectional view of an embodiment of a MEMS scanning mirror in which a high aspect ratio hinge connects actuators to a mirror.

FIG. 9E shows a MEMS scanning mirror using high aspect ratio hinges where each hinge includes a two co-planar plates.

FIG. 10 schematically illustrates an embodiment of the invention in which the distribution of mass and the spring constants associated with torsion or rotation of flexures are selected to provide resonances that are odd multiples of a scanning frequency.

FIGS. 11A and 11B illustrate different electrode patterns for sensors used in measuring rotation angles of MEMS scanning mirrors.

FIG. 12 is a circuit diagram for a MEMS scanning mirror in accordance with an embodiment of the invention employing feedback loops to control the shape of mirror oscillations about fast and slow axes.

FIG. 13 is a circuit diagram of a control circuit for rotations about one axis of a scanning mirror.

FIGS. 14A, 14B, and 14C show waveforms respectively of a reference signal, an error signal, and a drive signal used to produce triangular motion in a scanning mirror.

FIG. 15 shows a natural user interface system using a LADAR module in accordance with an embodiment of the invention.

Use of the same reference symbols in different figures indicates similar or identical items.

### DETAILED DESCRIPTION

In accordance with an aspect of the invention, a Laser Detection and Ranging (LADAR) system can include microelectromechanical system (MEMS) scanning mirrors, low resistance flexures or hinges, and drive circuits for continuous scanning in a relatively low cost, energy efficient, compact device.

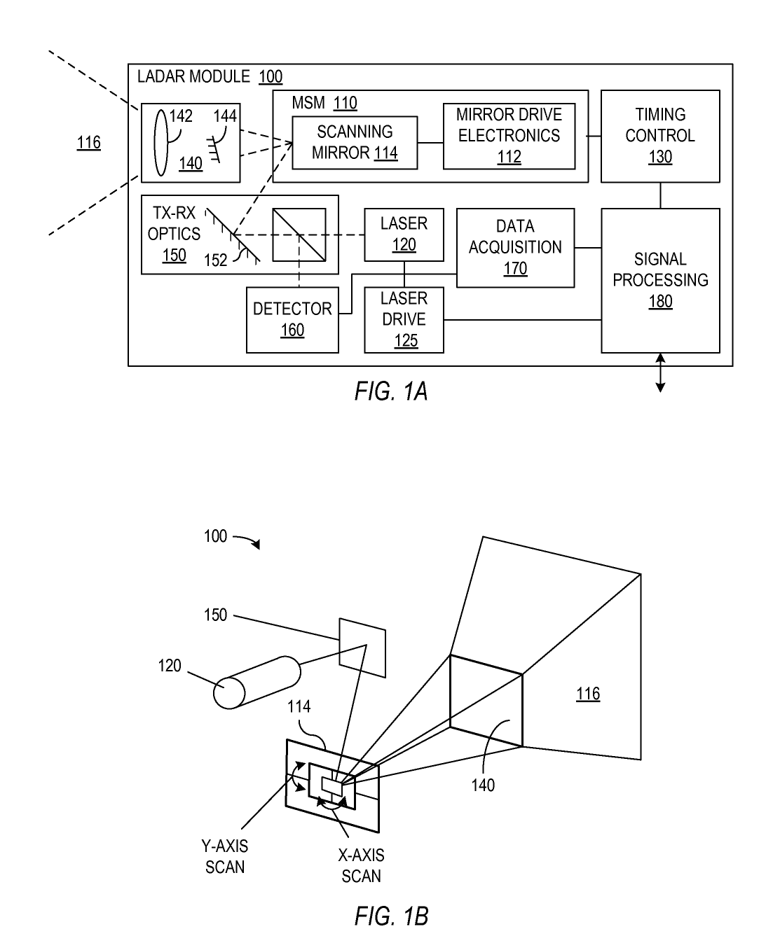

FIG. 1A is a block diagram of a LADAR system 100 that may be based on a micro-machined scanning mirror in accordance with an embodiment of the present invention, and FIG. 1B shows a perspective view of a portion of LADAR system 100 and a volume or space 116 scanned by LADAR system 100. LADAR system 100 includes a Mirror Scanning Module (MSM) 110, a laser system 120 with driver circuits 125, angle multiplier optics 140, transceiver optics 150, a light detector 160, a data acquisition circuit 170, a timing control circuit 130, and a signal processing unit 180.

Laser system 120 operates in a pulsed mode with pulse timing under the control of timing control circuit 130 or signal processing unit 180. The characteristics of laser 120 and laser drive circuits 125 used in LADAR module 100 may be chosen according to the desired performance parameters of LADAR module 100. In general, applications of LADAR module 100 may specify or require a specific range or maximum depth of scanned space 116 and resolution (e.g., number of pulses per scan line) that laser 120 must achieve. Laser 120 and drive electronics 125 may thus be chosen to provide a sufficiently high output power to provide an adequate reflected signal at a desired maximum range, a sufficiently short pulse duration to enable a desired range resolution, a sufficient pulse repetition frequency to match the motion of a scanning mirror 114 in MSM 110 and a desired number of measurement points per scan line, and a laser output wavelength in the infrared (IR) or other part of the electromagnetic spectrum to reduce background light interference and provide eye-safe operation. In an exemplary embodiment, laser 120 produces 1550 nm light or light with a range from 869 to 1550 nm. Other characteristics of laser 120 (e.g., environmental and package characteristics) may also be selected based on the above and further user-requirements, e.g., to provide a compact, lightweight, portable, and low input-power LADAR module 100.

The beam from laser 120 is directed through transceiver optics 150 before reflecting off a scanning mirror element 114 in MSM 110. Scanning mirror 114 preferably has a flat and continuous mirror surface rather than including an array of separate mirrors. In one embodiment, scanning mirror 114 has a continuous reflective surface that is about 4 mm by 4 mm square, but the reflective surface of scanning mirror 114 could have other shapes and sizes, e.g., circular, provided that the reflective surface is large enough to accommodate the transmitted beam and or collection of returning light. The reflectivity of scanning mirror 114 generally should be high, e.g., above about 90%, at the frequency of light produced by laser 120 for energy efficiency and to avoid overheating at the specific power and duty cycle of laser.

The reflective portion of scanning mirror 114 is rotatably mounted for scanning an incident beam through a raster type motion when a mirror drive system 112 drives scanning mirror 114 as described further below. In an exemplary embodiment, scanning mirror 114 has independently controlled oscillations about X and Y axes and provides up to about ±8° of rotation about each axis with triangular mirror motion. Other embodiments may have smaller ranges of motion or different angular ranges in X and Y directions, e.g., about 4° in the X direction and about 3° in the Y direction. Triangular motion ideally forces the mirror motion into a linear angular motion except at turning points where the motion reverses direction. With triangular motion, light pulse generated at a constant frequency can provide distance measurements that are evenly distributed through space 116. Providing triangular motion generally requires overcoming a natural tendency for sinusoidal oscillations. Techniques such as additional mirror drive inputs, additional resonators, and/or closed loop control as described further below may be used to provide triangular motion. Relatively large mirror rotations (e.g., ±8°) in a MEMS structure require either sufficient static force or dynamic multiplication effects provided by driving at resonance of the mechanical mirror system. Driving near resonance may be particularly useful for higher frequency motion, sometimes referred to herein as “fast axis” oscillations. For example, static driving below the rotational resonance about a “slow axis” and resonant drive at the natural frequency of a “fast axis” can be used for the slow and fast axes respectively. Magnetic, electrostatic, and/or piezoelectric drive mechanisms can be employed. However, piezoelectric drive may have the advantage of providing a self-contained drive mechanism and freedom from inherent constraints such as pull-in.

An optical angle multiplier 140 such as a lens 142 or other optical system can increase the angle of the transmitted scan beam to increase the angular range of LADAR module 100 and provide a larger scanned volume 116. Alternatively or additionally, a static (fixed) flat mirror 144 that reflects the already scanned beam back to scanning mirror 114 for a second reflection can increase the scan angle. However, for a second reflection, scanning mirror 114 may need a significantly larger area because reflection from mirror 144 will generally move the beam laterally. Angle multiplier 140 can thus increase the angle of the scan to produce a larger scanned volume 116 and correspondingly enhance the “field-of-view” of LADAR module 100.

Some of the laser light transmitted from angle multiplier 140 reflects off the surfaces of objects in scanned volume 116 and returns to LADAR module 100. FIG. 1A illustrates an embodiment in which the path of light returning to LADAR module 100 traverses angle multiplier 140, MSM 110, and transceiver optics 150 en route to detector 160. Such a configuration can provide directional selection of the returned light, which may improve the signal-to-noise ratio for returned light. Alternatively, separate receiver optics (not shown) could be used to direct light returning to LADAR module 100 into detector 160.

Detector 160, which can be a photodiode or similar light detector, receives the returning light and produces an analog signal representing the measured intensity of light having the transmitted frequency. Optical filters or frequency separation optics can be employed in detector 160 or receiver optics (e.g., optics 150) if detector 160 is otherwise insufficiently selective of the desired frequency. Data acquisition circuit 170 converts the analog signal from detector 160 into a digital signal and provides the digital signal to signal processing unit 180. Signal processing unit 180, which can be implemented using a general purpose microcontroller or microprocessor with suitable software or firmware, receives the signal from data acquisition circuit 170, identifies each pulse corresponding to reflected light in the digital signal, determines the time between transmission and return of the light, and determines a distance to a reflecting surface from the time of flight of the light pulse.

FIG. 1B shows schematically how mirror 114 oscillates on two axes to provide the scanning function. For ease of illustration, detectors and electronics required for LADAR functions are not shown in FIG. 1B. During operation, transceiver optics 150 directs a beam of light from laser 120 onto scanning mirror 114 of MSM 110. Mirror 114 oscillates back and forth through small angles around two perpendicular axes to cause scanning in X and Y directions in FIG. 1B. By setting the X scan at a rate proportionally higher than the Y scan rate, the laser beam scans through an optical field 116 having the shape of a “pyramidal cone.” The X-axis scan oscillates more rapidly, e.g., at a frequency of about 2000 Hz, and the Y-Axis scan oscillates at a lower frequency, e.g., about 8 Hz, which provides a raster-type motion including a series of scan lines that are slightly inclined and move back and forth through optical field 116. Laser pulses occur at discrete points in time during scanning and are typically separated by a period of time sufficient for light traversing the maximum distance range to return to LADAR module 100 before the next pulse is transmitted.

Timing control circuit 130 can produce a master timing signal for control and synchronization of laser driver 125, mirror scanning module 110, and signal processing unit 180 so that signal processing unit 180 can identify each transmitted pulse and the corresponding returning pulse of light. As a result, signal processing unit 180 produces a series of measurements of the distances to reflecting surfaces in scanned space 116, and each distance corresponds to a specific direction in the scan pattern of MSM 100. Accordingly, each scan through space 116 produces a two-dimensional array or frame of distance measurements that indicate the locations of points on reflecting surfaces in space 116. Signal processing unit 180 can include an interface for transmission of a series of distance measurements or a series of distance measurement frames to a computer or memory system that uses or records temporal changes in the three-dimensional volume of scanned space 116.

In one embodiment that may be used for automotive systems, LADAR module 100 provides a frame rate of about 15 fps (frames per second) with an image resolution of 320 pixels or distance measurements per scan line (e.g., per horizontal line), 240 scan lines per frame, and a maximum distance measurement of about 100 m. Other embodiments (e.g., for Natural User Interface applications) may have different requirements, e.g., a higher frame rate of 30 fps or 60 fps, resolution of 640×480 or higher, and a reduced maximum range (to about 12 m or less).

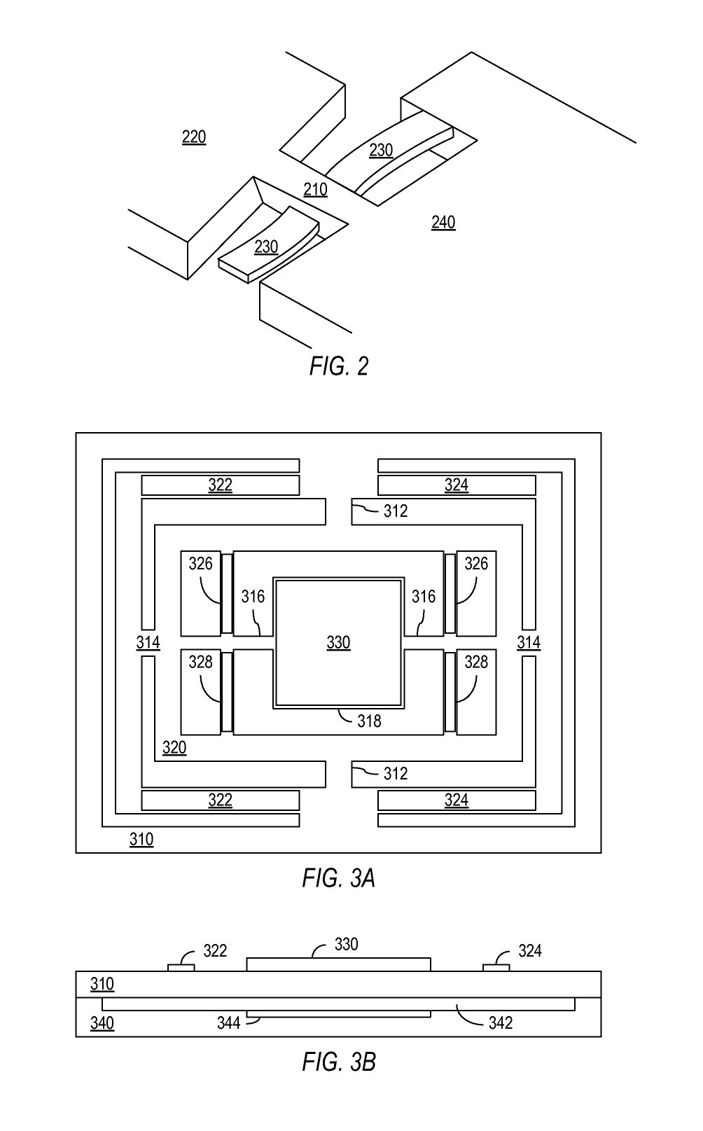

MSM 110 can use a variety of MEMS based mirror configurations to achieve desired frame rates and field of view for LADAR system 100. In one scanning mirror configuration, torsional flexures 210 as shown in the partial cutaway view of FIG. 2 connect a mirrored surface 220 to a frame 240 and guide the scanning motion of mirrored surface 220 relative to frame 240. In particular, mirror 220 may be suspended from two torsional flexures 210 connected to frame 240 on either side of mirror 220 to define a rotation axis corresponding to twisting of flexures 210. Two actuators 230 connect each flexure 210 to frame 240 and operate to twist flexures 210 along the long axis flexures 210. FIG. 2 shows mirror surface 220 with one of the two torsional flexures 210. Two actuator flexures 230 drive movement of flexure 210, e.g., using thin layers of piezoelectric material in the flexures, and four actuators 230 counting actuators coupled to the opposite flexure (not shown in FIG. 2) rotate mirror 220.

FIG. 3A shows a plan view of a MEMS mirror structure 300 including an outer frame or base 310, an inner frame 320, and a mirror 330. MEMS mirror structure 300 can be fabricated by etching a multilayer structure to produce mirror 330, frame 320, and base 310 with intervening flexures 312 and 313 and actuators 322, 324, 326, and 328. The multi-layer structure may, for example, include a base substrate such as a stainless steel, semiconductor, or semiconductor on insulator (SOI) substrate on which actuator layers are deposited. Mirror 330 can be formed from a layer of a reflective material such as gold that may be sputtered onto a mirror area 318 of the base substrate.

MEMS mirror structure 300, particularly base 310, can be mounted or affixed on a printed circuit board (PCB) 340 as shown in the cross-sectional view of FIG. 3B. The mounting on PCB 340 leaves a gap under mirror 330 between MEMS structure 300 and PCB 340 that allows mirror 330 to rotate. PCB 340 can further provide electrical connections to actuators 322, 324, 326, and 328 through traces (not shown) on MEMS structure 300 or wires (not shown) connected to actuators 322, 324, 326 and 328 or other electrical devices on MEM structure 300. PCB 340 also includes an angle sensor 344 positioned to measure the orientation or rotation angles of mirror 330. Measurements using angle sensor 344 can use electrostatic, piezoresistive, or capacitive sensing technology.

Actuators 322, 324, 326, and 328 can be formed using a piezoelectric structure that bends or arches in response to an applied voltage. Piezoelectric material such as zinc oxide (ZnO) can be applied to MEMS mirror 300 using a thin film, spin on, or SolGel process. In operation, actuators 322 and 324 bend in opposite directions to raise one end of frame 320 and lower the other end of frame 320. Flexures 312, which connect frame 320 to base 310 and define a slow axis of rotation of mirror 330, are thin enough (10 to 50 μm) to twist when actuators 322 and 324 apply force to frame 320 through hinges or connectors 314, thereby lifting one end of frame and pushing down the opposite end of frame 320. Mirror 330 and underlying support area 318 are connected to frame 320 through flexures 316 that are perpendicular to flexures 312. Actuators 326 and 328 directly connect to flexures 316 and act to twist flexures 316 and rotate mirror 330 about a fast axis when actuator drive voltages are applied.

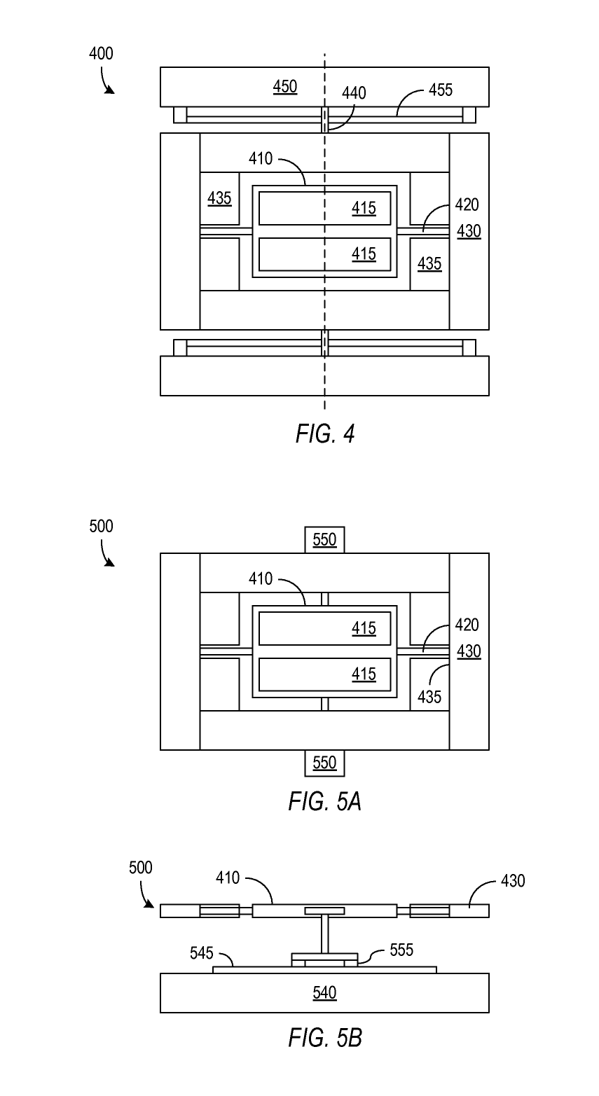

FIG. 4 shows a plan view of the underside or back of a MEMS mirror structure 400 including a mirror area 410 connected to a frame 430 by flexures 420. Flexures 420 permit rotation of mirror area 410 about a fast axis and may include electrical traces that connect to electrodes 415 on the back of mirror area 410. Electrodes 415 can therefore be electrically charged for electrostatic actuation, e.g., using electrical signals applied to electrodes in a PCB (not shown) under electrodes 415. Fast axis oscillations may be at rates of around 2 kHz in an exemplary embodiment of the invention. One or more of electrodes 415 can also be shaped and positioned for measurement of an angle or orientation of mirror area 410 relative to fixed underlying sensing electrodes in the underlying PCB (not shown). In particular, the capacitance between selected electrodes 415 and the underlying sensing electrodes will vary with the rotation angle of mirror area 410.

Frame 430 is connected to a base 450 by flexures 440 that permit rotation of frame 430 about a slow axis of mirror rotation. Flexures 440 are connected to piezoelectric actuators 455 that actuate rotation of frame 430 as described above with reference to FIG. 2. In an exemplary embodiment of the invention, slow axis rotations are at rates less than about 8 to 20 Hz to achieve a frame rate of about 15 to 40 Hz. Frame 430 may additionally include electrodes 435 for a sensing system that measures the rotation angle of frame 430.

FIG. 5A shows a top view of a MEMS mirror system 500 that also uses a combination of electrostatic and piezoelectric actuation. MEMS mirror system 500 includes a mirror area 410 connected to a frame 430 by flexures 420 as described with reference to FIG. 4. However, frame 430 is rigidly mounted on a tilt structure 550 with actuators 555 as shown in FIG. 5B. In operation, a difference in the lengths of actuators 555 tilts structure 550 and controls a tilt angle of frame 430 about the slow axis. FIG. 5B also shows a PCB or other substrate 540 that underlies electrodes 415 and 435 and includes electrodes 545 that can be used for electrostatic actuation of rotations of mirror area 410 about the fast axis and/or for measurement of the rotation angles of MEMS mirror system 500 relative to PCB 540.

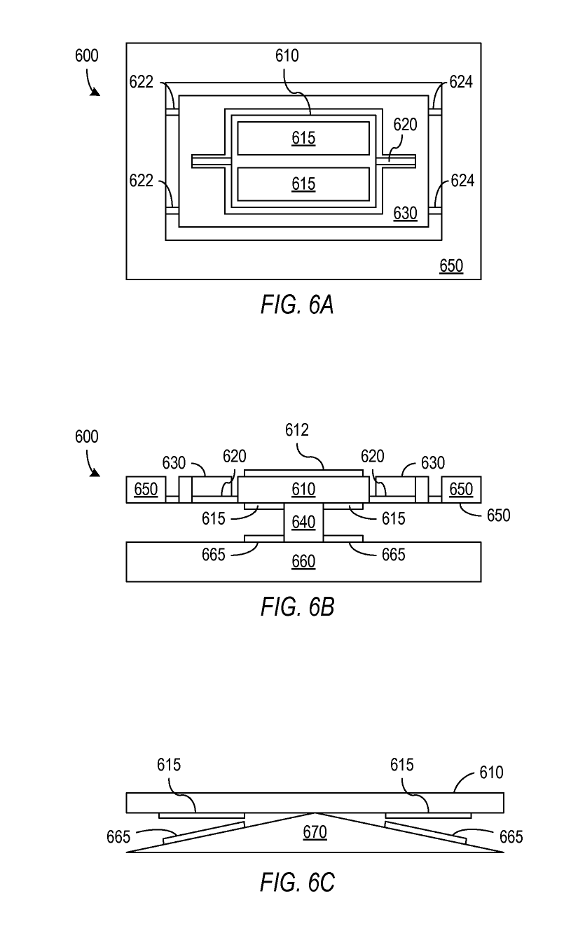

FIG. 6A shows a plan view of another MEMS mirror system 600 containing a mirror area 610 mounted via flexures 620 on a frame 630, which is mounted on an outer frame or base 650 via actuators 622 and 624. A pair of electrodes 615 are formed on the underside of mirror area 610 opposite to a reflective area 612 formed on the top side of mirror area 610 as shown in FIG. 6B. For slow axis rotation of mirror area 610, actuators 622 and 624 connect to opposite ends of frame 630 and are operated so that actuators 622 lift or lower one end of frame 630 when actuators 624 lower or lift the opposite end of frame 630. With actuation through bending of four symmetrical actuators 655, the torsion of flexures may not be required, which reduces the resistance to rotation of frame 630.

FIG. 6B further shows how the fast axis of mirror 610 can be electrostatically actuated using electrodes 615 on mirror area 610 and electrodes 665 on an underlying substrate 660 such as a PCB. In particular, when the voltage on one of electrodes 615 is of a polarity opposite to the voltage on an underlying electrode, electrostatic forces pull that electrode 615 on mirror area 610 toward the corresponding electrode 665 on substrate 660. When the voltage on one of electrodes 615 of the same polarity as the voltage on an underlying electrode, electrostatic forces repel that electrode 615 on mirror area 610 from the corresponding electrode 665 on substrate 660. A standoff 640 connects substrate 660 to base 650 so that mirror area 610 and frame 630 are free to rotate without hitting substrate 660.

An alternate embodiment for fast axis electrodes 665 can be driven with inclined electrodes 665 as shown in FIG. 6C. In the embodiment of FIG. 6C, a substrate 670 on which electrodes 665 are formed has an apex on which mirror area 610 could pivot. However, in this configuration, substrate 670 must be attached to frame 630 and rotate with frame 630 in response to operation of actuators 622 and 624. Alternatively, a standoff (not show) can provide separation between mirror area 610 and substrate 670, so that mirror area 610 can rotate about both the fast and slow axes relative to substrate 670.

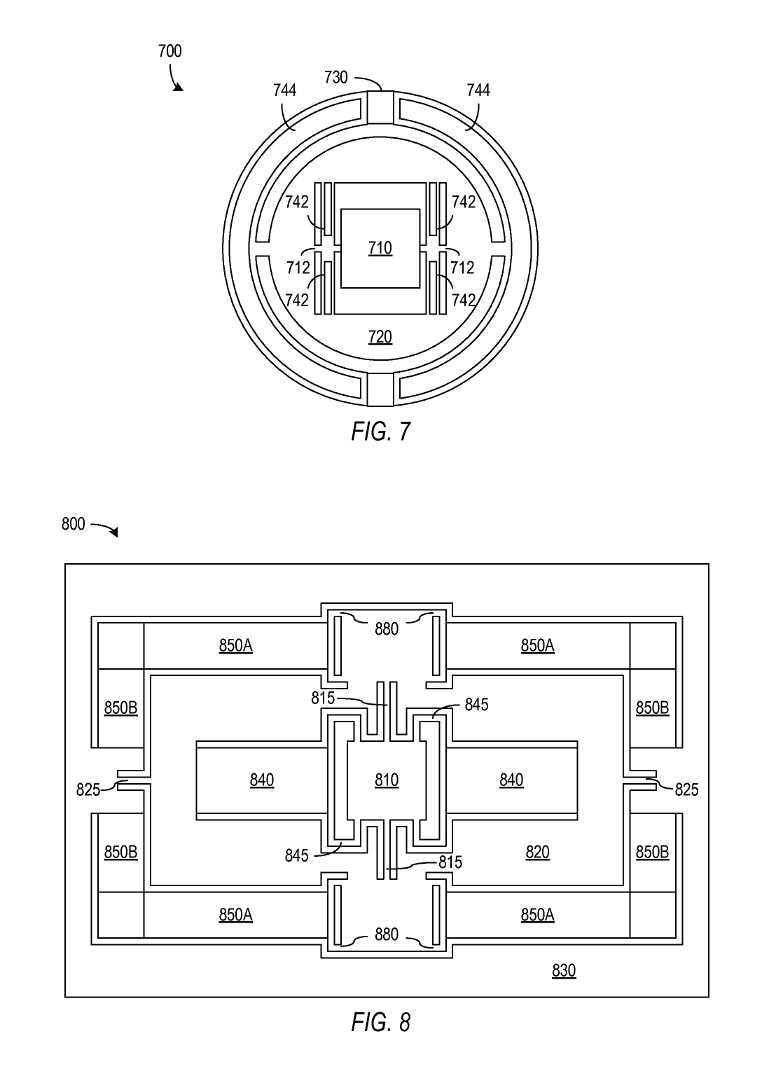

FIG. 7 shows a MEMS mirror system 700 in which actuation of fast and slow axes of a mirror area 710 are both by piezoelectric actuation. However, in mirror system 700, the fast axis drive is achieved with four symmetrical cantilevered piezoelectric beams 742 coupled to flexures 712 that extend between a frame 720 and mirror area 710. The slow axis oscillations are driven with two semi-circular piezoelectric actuators 744 that are coupled to a base 730 and frame 720. Use of actuators 744 with semi-circular or more generally non-linear shapes can increase the length of the actuators that fit within the boundaries of MEMS mirror system 700 and thus increase the amount of travel or movement that actuators 744 can convey to frame 720.

FIG. 8 shows a MEMS mirror system 800 in accordance with another embodiment using piezoelectric actuation on both fast and slow axes and using non-linear actuators to drive one axis. MEMS mirror system 800 includes a mirror area 810 connected to a frame 820 through flexures 815 that define the direction of the fast axis. Frame 820 in turn is connected to an outer frame or base 830 through flexures 825 that define a slow axis that is perpendicular to the fast axis. Actuators 840 drive oscillations of mirror area 810 about the fast axis and are connected to mirror area 810 through associated hinge structures 845. In the embodiment of FIG. 8, hinges 845 can be formed through patterning and thinning of the substrate from which mirror area 810 is formed. In particular, each hinges 845 includes a ring of flexures that bend and stretch as the ends of an attached actuator 840 adjacent to mirror area 810 rises or falls. The relatively small size of features in hinges 845 reduces the mechanical resistance to rotation of mirror area 810 as actuators 840 move. Accordingly, a higher oscillation frequency can be achieved. Actuators that connect to frame 820 for rotation of mirror region 810 about the slow axis are similarly connected to frame 820 through hinge structures 880 to reduce mechanical resistance to slow axis oscillations.

Each of four actuators used to drive oscillations of frame 820 about the slow axis includes two parts 850A and 850B that have a non-linear arrangement. The greater combined length of the parts 850A and 850B forming an actuator gives each of these actuators a greater range of movement, which may permit a greater angular range for slow axis oscillations.

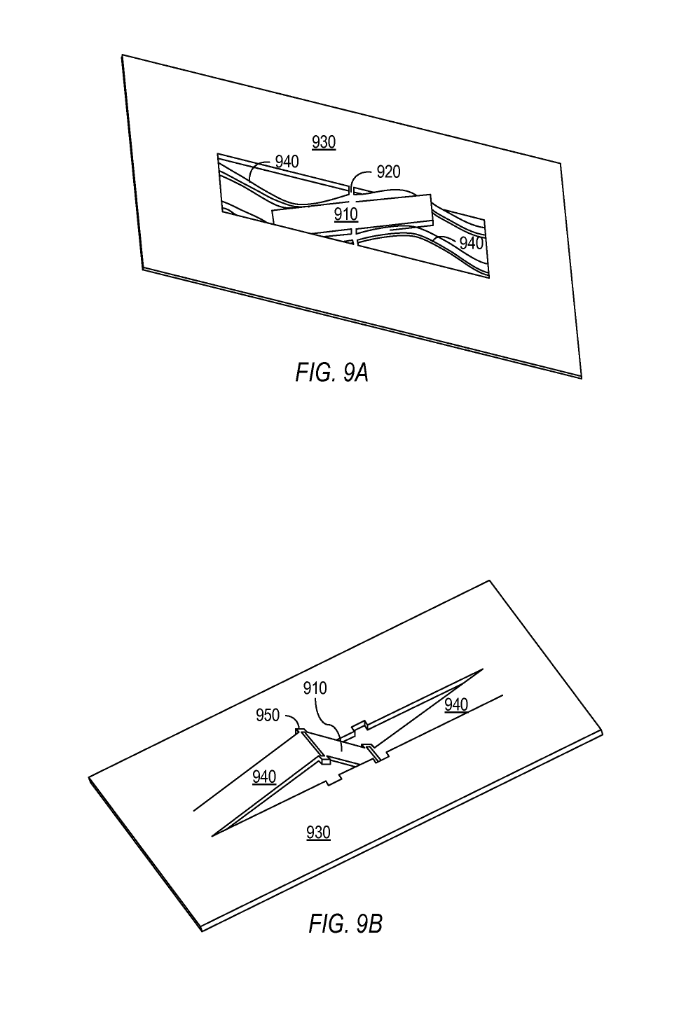

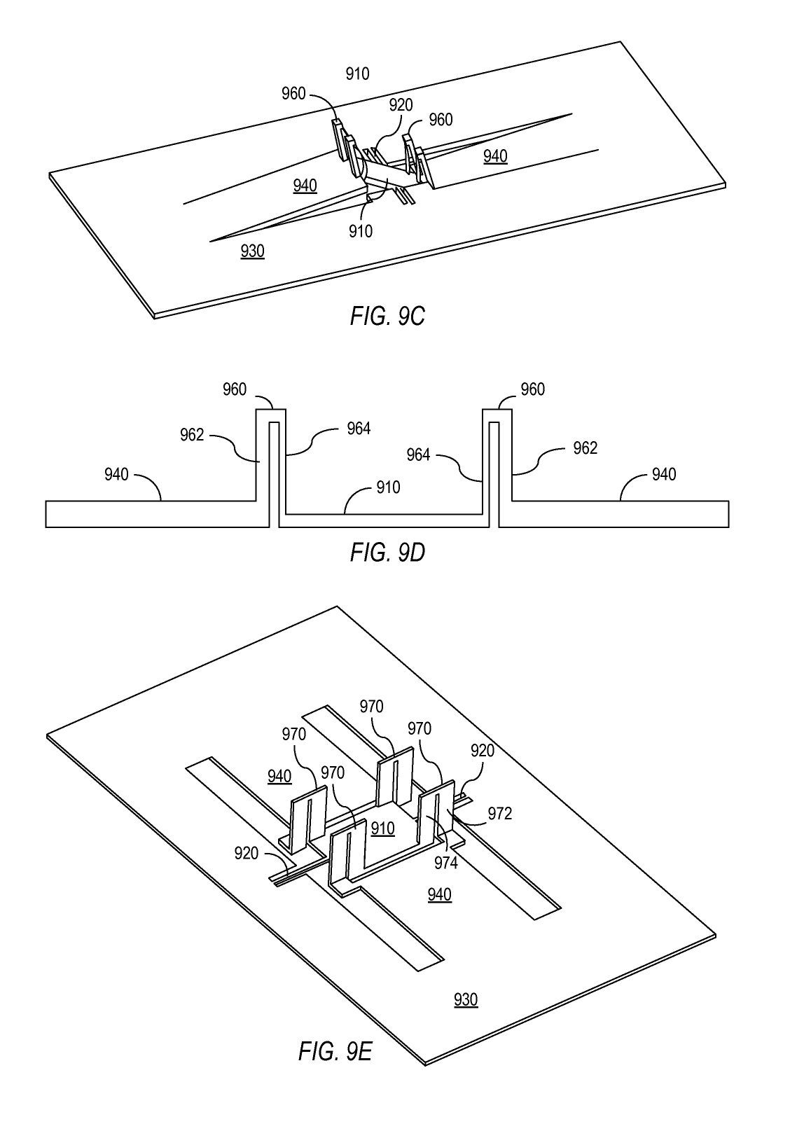

FIGS. 9A, 9B, 9C, 9D and 9E illustrate hinge configurations for a few different embodiments of the invention. FIG. 9A, for example, shows a scanning MEMS system that has a mirror area 910 connected to a pair of flexures 920, extending from a gimbal or frame 930 to mirror area 910. In the embodiment of FIG. 9A, two actuators 940 can be connected asymmetrically to each flexure 920, so that operation of actuators 940 twists flexures 910 and rotates mirror 910.

FIG. 9B shows a scanning MEMS system that has a mirror area 910 having a pair of hinges 950 that connect mirror area 910 respectively to a pair of actuators 940. Each actuator 940 extends from a gimbal or frame 930 to its associate hinge 950. Hinges 950 connect to opposite ends of mirror area 910, so that operation of actuators 940 has greater leverage for rotating mirror 910. Hinges 950 are shaped to flex and accommodate changes in the angle between the surfaces of actuators 940 and mirror area 910 as mirror area 910 rotates relative to frame 930. Each hinge 950 can also stretch or contract to accommodate changes in the distance between the end of mirror area 910 and the attached end of actuator 940. In the embodiment of FIG. 9B, hinges 950 can be formed by patterning the same multilayer structure from which mirror area 910, frame 930 and actuators 940 are formed.

FIG. 9B also illustrates a configuration of a MEMS scanning mirror that does not use torsional flexures to constrain rotation of mirror area 910. Instead, mirror area 910 is suspended by actuators 940, which are connected to mirror area 910 through hinges 950, and the movement of actuators 940 control the rotation of mirror 910. The elimination of torsional flexures can decrease mechanical resistance to rotation of mirror area 910 and facilitate higher frequency oscillations of mirror area 910 during scanning

In the embodiment of FIG. 9C, each of two actuators 940 connect mirror area 910 through a pair of high aspect ratio (HAR) hinges 960, so that operation of actuator 940 rotates mirror 910. HAR hinges 960 flex to accommodate changes in the angle between the surface of actuators 940 and mirror area 910 and changes the distance between the end of mirror area 910 and actuator 940 as mirror area 910 rotates. Flexures 920, which directly connect mirror area 910 to frame 930, are provided in the embodiment of FIG. 9C to define the axis of rotation of mirror area 910 relative to frame 930, but alternatively could be eliminated to reduce mechanical resistance to rotation as described above with reference to FIG. 9B.

FIG. 9D shows a cross-section through mirror 910 and two of the HAR hinges 960 that connect mirror area 910 to respective actuators 940. In the embodiment of FIG. 9D, each HAR hinge includes two plates 962 and 964, where one plate 962 is thicker and more rigid that the other plate 964. For example, plate 962 may be about 200 μm, and plate 964 may be about 50 μm. The thinner and more flexible plate 964 can bend to accommodate changes in the angle and separation between mirror area 910 and the connected actuator 940 during actuation.

FIG. 9E shows an embodiment of a scanning MEMS mirror system in which each HAR hinges 970 has two plates 972 and 974 that are laterally separated from each other or even in approximately the same plane. For each HAR hinge 970, one plate 972 or 974 connects to an actuator 940 and the other plate 974 or 972 connects to mirror area 910. Arrangement of plates 972 and 974 in this manner can increase the angular range of hinges 970 because rotations of each plate 972 or 974 is not stopped by the other plate 974 or 972. Plates 972 and 974 can be of different thicknesses as described with reference to FIG. 9D so that most of the bending in each hinge 970 occurs in the more flexible plate 972 or 974. FIG. 9E also shows that HAR hinges 960 can be shifted along the direction of the rotation axis to prevent HAR hinges 970 from blocking light beams reflected from mirror area 910. Torsional flexures 920, which connect mirror area 910 to frame 930 in FIG. 9E and define a rotation axis, are optional and may be removed so that mirror area 910 is solely supported by actuators 940 via hinges 970.

The MEMS mirror systems described above can generally be fabricated using know semiconductor fabrication techniques for forming MEMS structures. For example, a fabrication process can start by depositing a first metal layer, a thin layer of piezoelectric material, and a second metal layer on a semiconductor or semiconductor-on-insulator substrate. Multiple photolithographic and etching processes can then be employed to define the areas of piezoelectric actuators including piezoelectric material sandwiched between upper and lower electrodes, create conductive traces from the metal layers, and thin or etch through the substrate to separate the mirror area, inner frame, and outer frame or base and to create flexures or flat hinges. Areas of the substrate can generally be thinned where desired through a top or back etch process. For embodiments of the invention employing HAR hinges, photolithograph and etching process can create alignment features such as grooves on the substrate, and the hinges can be created in a separate process and attached, e.g., glued using an epoxy, to the substrate using semiconductor processing methods.

An alternative process can fabricate MEMS mirror systems without requiring the clean room environment normally used for semiconductor processing. In particular, instead of using a semiconductor or SOI substrate, a metal substrate (e.g., stainless steel substrate) can be coated with piezoelectric material, and a multi-step etching process can create gaps and regions of different thicknesses needed for different structures. For example, the main material may be 500-μm thick stainless steel. A first etch step removes 200 μm to thin areas such as mirror area 1010 to decrease weight or create grooves for attachment of HAR hinges. A second etch step removes a total of 400 to 450 μm to leave regions thin enough to act as flexures. A final etch process etches through where separations between areas are required. Actuator areas, particularly areas for actuators that drive fast axis scanning of a mirror area, may further include a pattern of holes that may be etched through the actuator areas to further lighten those areas for fast actuation. Layers of piezoelectric material (e.g., PZT) can be coated on one or both sides of the actuators areas. Thin layers of piezoelectric material (e.g., PZT 2 to 125 μm thick) may be preferred again for faster actuation. It may be noted that although these etching processes can be implemented using conventional integrated circuit or semiconductor processing techniques, the dimensions of area are typically large enough that stringent clean room techniques may be unnecessary, thereby allowing lower manufacturing costs.

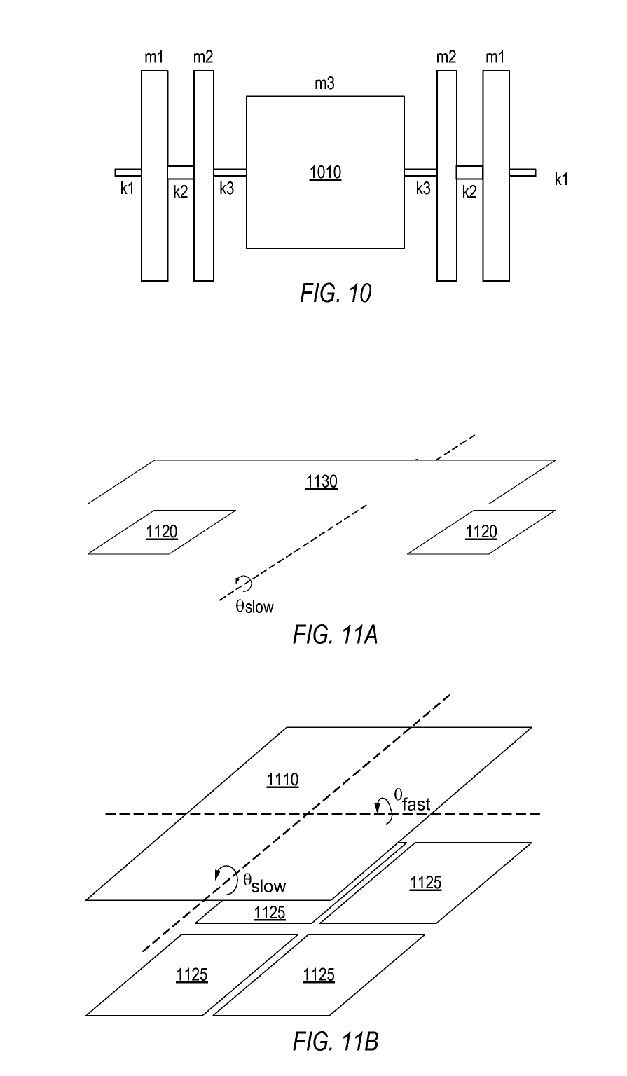

In accordance with another aspect of the invention, scanning mirrors can be driven to provide a trianglular motion in which the angular velocity is constant except at the turning points. However, mechanical systems generally have a tendency for sinusoidal oscillation at a characteristic or resonant frequency of the mechanical system. To aid in providing triangular motion, the mass distribution of the system and the spring constants of flexures or hinges can be selected so that resonant oscillations are at odd multiples of a desired scan frequency. For example, FIG. 10 illustrates a mirror area 1010 with a moment of inertia m3 coupled to additional structures having moments of inertia m1 and m2 through flexures having torsion spring constants k1, k2, and k3. If mirror oscillations in a MEMS mirror system are intended to be at a frequency f (for example, f=1990 Hz for the fast axis and f=15 Hz for the slow axis), factors such as the moments of inertia m1, m2, and m3 and the spring constants k1, k2, and k3 of the flexure are chosen so that characteristic resonant frequencies of the mirror include odd multiples of the scan frequency, e.g., resonant frequencies of f, 3f, and 5f. If driving moment m3 couples energy equally into the resonant modes of masses suspended with spring constants k1, k2, and k3, the net movement of the mirror can approximate a triangular motion because Fourier expansion of a triangle wave is a sum of sine waves at frequencies f, 3f, 5f, etc.

A LADAR system, having a mirror structure with natural mechanical modes that are odd multiples of the desired oscillation frequency or not, can employ feedback loops using sensors to measure the movement of the scanning mirror and controllers that generate actuator drive signals that produce the desired triangular motions. FIGS. 11A and 11B illustrate the arrangement of plates for capacitive sensing of the orientation of a mirror in a MEMS scanning system. In particular, FIG. 11A shows a frame 1130 of the MEMS scanning system having two underlying plates 1120 positioned on opposite sides of the slow rotation axis. Frame 1130 only rotates about the slow axis, so that capacitance of one plate 1120 will increase as frame 1130 rotates about the slow axis to bring an electrode on frame 1130 closer to that electrode 1120. At the same time, capacitance of the other plate 1120 with frame 1130 decreases. FIG. 11B illustrates how four plates 1125 can be positioned under a mirror 1110 in the four quadrants defined by the slow axis and the fast axis. Mirror 1110 tilts about the fast and the slow axis, so that the capacitance that each plate 1125 has with mirror 1110 (or an electrode on mirror 1110) depends on how close tilting brings the mirror to the plate. Ratios of the four capacitances can be used to determine both tilt angles of mirror 1110. Measuring circuits connected to the capacitive plates 1120 and/or 1125 shown in FIGS. 11A and 11B can produce signals indicating rotation angles θ_{fast} and θ_{slow} of mirror 1110, and a control circuit can use the sensor signals to determine how to drive actuators to achieve the desired motion, e.g., provide triangular motion.

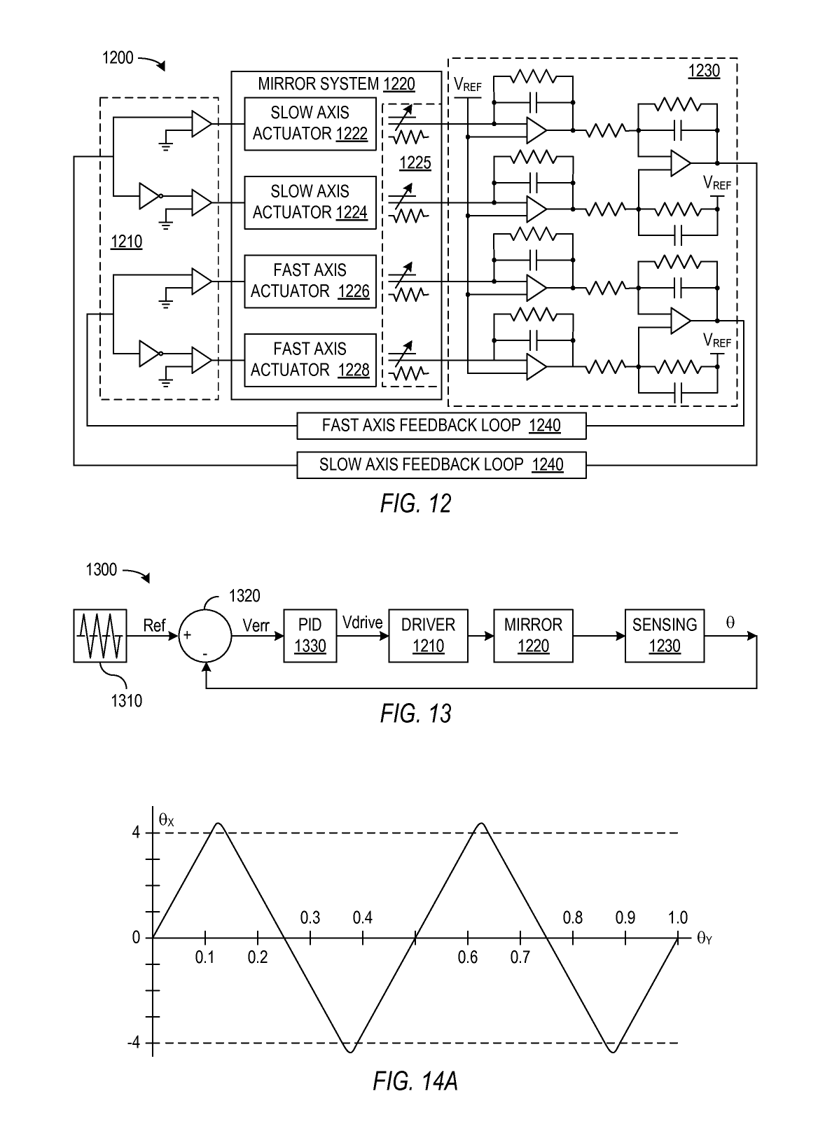

FIG. 12 shows the basic configuration of the electrical circuits in a mirror scanning module 1200. The circuitry includes driver circuits 1210 for slow axis actuators 1222 and 1224 and fast axis actuators 1226 and 1228 in a MEMS scanning mirror 1220 and sensing circuits 1230 coupled to sensing plates 1224 in mirror system 1220. In an exemplary embodiment, sensing plates 1225 have capacitances that vary with the position of the scanning mirror as described above with reference to FIG. 11B. Control circuits 1240 complete feedback loops and use the measurements signals from sensing circuits 1230 to generate control signals for drive circuits 1210.

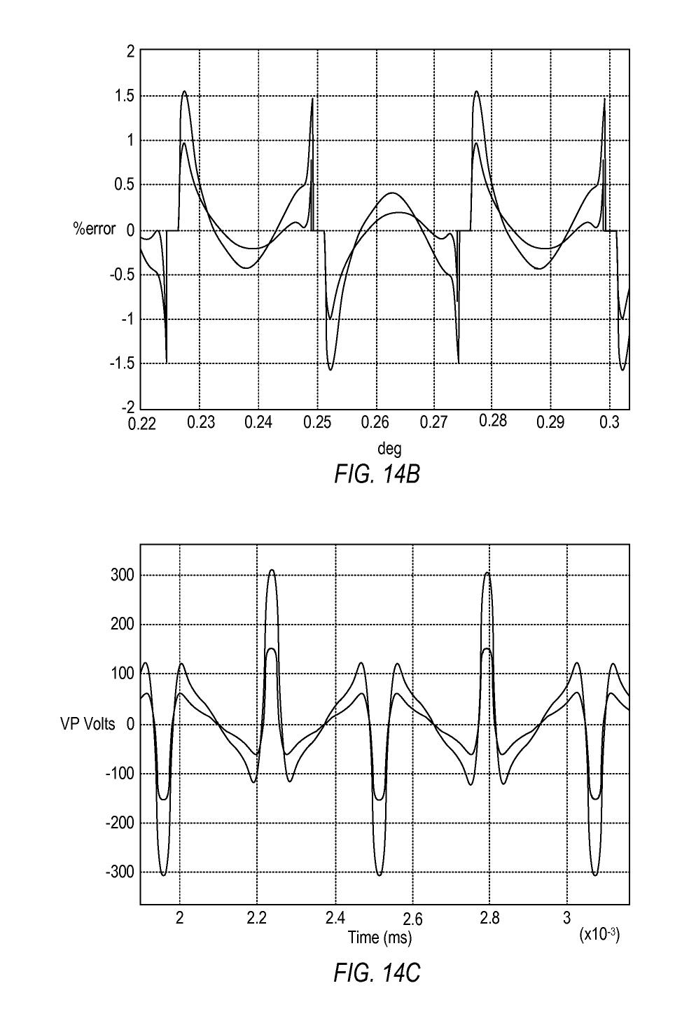

FIG. 13 illustrates control circuitry in a feedback loop 1300 for control of actuators associated with one rotation axis of a scanning mirror. In general, a MEMS scanning mirror module would include two feedback loops 1300 that ensure triangular motion of the mirror with a frequency of about 2 kHz for the fast axis and a frequency of about 20 Hz for the slow axis. Feedback loop 1300 uses a reference signal generator 1310 and a proportional-integral-derivative (PID) controller 1330. In particular, reference generator 1320 generates a reference target signal Ref, which may approximate a triangle wave as shown in FIG. 14A. The reference wave does not need to be a perfect triangle wave since triangular motion is generally only required for a portion, e.g., 90%, of the scanning cycle, so that rounding of the reference voltage curve near the reversal in angular velocity is permitted. The frequency of the reference signal depends on whether actuators for the fast or slow axis are being controlled.

Sensing circuits 1230 sense the angular displacement of the mirror, e.g., as a change in capacitance, and a charge amp can convert the capacitance change into the voltage of a sensed signal θ. A gain stage (not shown) can amplify sensed signal θ for comparison to the target reference signal ref by a subtractor 1320. FIG. 14B shows a resulting difference or error signal Verr for two different mirror architectures. The error is fed into the PID controller 1330. FIG. 14C shows a drive signal Vdrive from PID controller 1330 for two different mirror architectures. The resulting drive voltage Vdrive is applied through driver circuits 1210 to the piezoelectric actuators which are in mirror block 1220.

LADAR systems such as described above have many uses including, for example, collision avoidance and parking systems in automobiles and vision systems for robots. Another use of LADAR systems is for a Natural User Interface (NUI) for a computer system, such as a personal computer or a game console. Some NUI systems currently use “Triangulation” Technology (TT) to sense 3D spatial information. In contrast, LADAR uses time-of-flight (TOF) technology to sense 3D spatial information. There are areas where TOF may have advantages over TT as follows.

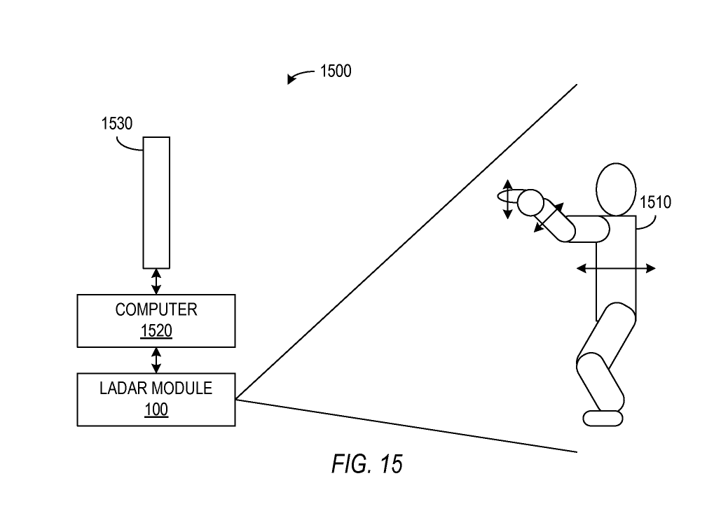

FIG. 15 shows an example of a computing system 1500 with an NUI using a LADAR module 100 such as described above to detect actions of at least one user 1510. Computing system 1500 further includes a computer 1520 connected to LADAR module 100 and other conventional computer system components 1530 such as a display connected to computer 1520. NUI systems often do not require control devices such as a mouse or a game controller, since the NUI operation can replace the functions of such control devices, but other control devices could be employed in system 1500 if desired. Computer 1520 may be a conventional personal computer or game console or a portable device such as a laptop computer, a PDA, or a smart phone that receives measurements from LADAR module 100. LADAR module 100 and system components 1530 are shown in FIG. 15 as devices separate from computer 1520, but LADAR module 100 and system components 1530 could be incorporated in the same case or integrated structure as computer 1520.

LADAR module 100 can measure the time-of-flight for a light pulse that travels from LADAR module 100 to user 1510 or a solid object in the surroundings of user 1510 and then returns to LADAR module. LADAR module provides the measured times or derived distance measurements to computer 1520. A distance measurement for LADAR module 100 is simply the product of a time-of-flight measurement and the speed of light. In general, LADAR module 100 can construct a frame of distance measurements by scanning the laser beam through the desired field of view as described above. Computer 1520 may contain a program module (not shown) that uses the frames of spatial measurements from LADAR module 100 to identify the location of user 1510, movement of user 1510, and possible specific movements of body parts such as the legs, arms, hands, or fingers of one or more users 1510. Changes such as changes in facial details caused by moving one's mouth or jaw or blinking one's eyes may be detected using LADAR or separate imaging and image analysis systems (not shown). The measured movements can then be interpreted as control instructions for a program being run on computer 1520, e.g., to control the action of a curser, select program objects, enter information, or operate a game program.

The operating parameters of LADAR module 100 for an indoor application that is expected to be most common for NUI systems may be different from parameters that may be optimal for outdoor applications such as uses of LADAR systems in automobiles. For NUI use, the field of view may be on the order or 45° or more, and the desired range of measurement may be roughly from a minimum distance of about 0.3 to 1 m and a maximum of about 5 to 10 m. The resolution of each frame may be sufficient to detect leg, arm, hand, and possibly finger movements of user 1510 when the user is within the target range of LADAR module 100. A frame containing 640×480 distance measurements may be suitable for many NUI systems. The frame rate needed for an NUI system will generally depend on the reaction rate required for the programs being controlled. For example, frame rates similar to those used for video (e.g., 15 fps to 60 fps) may be desired in order to simulate smooth control of a program or a fast action game. The LADAR modules described may have physical parameters that are adjusted to optimize performance for a particular NUI system.

NUI systems using LADAR time-of-flight (TOF) technology may provide the following advantages over NUI systems using triangulation technology (TT).

a) Range Resolution-1: TT has good resolution at a specific distance (e.g., 1 cm at 3 m) but the resolution quickly degrades with distance. TOF LADAR systems can be designed for long ranges, and there is no inherent limit to improving the resolution and TOF range. In particular, the resolution of a TOF system is fundamentally independent of distance. NUI systems using TOF may be able to provide required sensing resolution at a much greater range than can be provided by TT systems.

b) Range Resolution-2: TOF range resolution is dictated by the time duration of four basic steps in the creation of range values: pulse generation time, detector speed, signal processing time, and backend processing time. The backend processing times are not a problem factor for achieving higher resolutions, but all the other steps can be. For TOF to achieve the desired level of range resolution for NUI, use of high-performance or custom devices for pulse generation, detection, backend and signal processing may be needed.

c) Range Resolution-3: TT determines distance by computing the difference between the 2D dot or grid patterns projected onto surfaces separated by some distance from the TT sensor. TT range resolution depends on analyzing the 2D pattern projected on all surfaces. Hence, measurements depend on the spatial resolution of a 2D pattern and frame rates depend on the speed of available video or image sensors. In TOF, there is no such 2D resolution requirement; there simply is round-trip pulse detection from individual points on the surfaces.

d) Lag-Time: TT is computation intensive, which may cause time delays between the user's action and the corresponding display of that action on a computer display. Such delays are a big problem in high speed action games and other potential applications. TOF is much less computation intensive. Again, for example, TT determines distance by computing the difference between the 2D dot patterns projected on all surfaces some distance from the TT sensor. In TOF, there is no such calculation; there is simply pulse detection from individual surfaces at each point (pixel). Hence TOF could reduce lag times and increase the speed and time resolution of a NUI system.

e) Frame Rate (fps): Although a frame rate of 15 fps (for a 100 m range LADAR) are primarily described above, higher frame rates are more easily achieved when the maximum range of a LADAR system is shortened to the few meters that NUI systems need. The relationship between the fps and range depends on several other performance specifics, and there is plenty of room to increase a LADAR system to the NUI's 30 fps or even 60 fps. Further, high frame rates may be difficult and expensive to achieve with TT systems because TT systems use 2-D image sensors and very high frame rate video sensors may be expensive and difficult to obtain.

Although embodiments of the invention have been described to illustrate specific examples, the description of such examples and should not be taken as a limitation. Various adaptations and combinations of features of the embodiments disclosed are within the scope of the invention as defined by the following claims.

What is claimed is:

1. A scanning mirror system comprising:
a substrate patterned to include a mirror area, a frame around the mirror area, and a base around the frame;
a first actuator coupled such that operation of the first actuator rotates the mirror area about a first axis relative to the frame; and
a second actuator coupled such that operation of the second actuator rotates the frame about a second axis relative to the base.

2. The system of claim 1, wherein the substrate further comprises a flexure connecting the mirror area to the frame, the flexure being oriented along the first axis.

3. The system of claim 2, wherein an end of the first actuator is coupled to the flexure and operation of the first actuator twists the flexure.

4. The system of claim 1, wherein the substrate further comprises a hinge connecting the first actuator to the mirror area.

5. The system of claim 1, further comprising a hinge connected to the first actuator and to the mirror area, wherein the hinge extends in a direction perpendicular to the substrate.

6. The system of claim 5, wherein the hinge includes a first plate and a second plate, wherein a bottom edge of the first plate is connected to the mirror area, a top edge of the first plate is connected to a top edge of the second plate, and a bottom edge of the second plate is connected to the first actuator.

7. The system of claim 6, wherein one of the first and second plates is thinner than the other.

8. The system of claim 5, wherein the hinge includes a first plate and a second plate that are coplanar.

9. The system of claim 8, wherein one of the first and second plates is thinner than the other.

10. The system of claim 1, wherein the mirror area is suspended from the frame by a plurality of actuators including the first actuator.

11. The system of claim 1, wherein at least one of the first and second actuators comprises a region of piezoelectric material on a portion of the substrate.

12. The system of claim 11, wherein the region of piezoelectric material has a non-linear shape in a plane of the substrate.

13. A LADAR system comprising:
a MEMS mirror containing a mirror mounted for scanning rotations about a first axis and about a second axis; and
a driver system coupled to drive the mirror for continuous oscillations providing scanning about the first axis at a first frequency and about the second axis at a second frequency that is lower than the first frequency.

14. The system of claim 13, wherein the continuous oscillations about the first axis provides triangular motion of the mirror.

15. The system of claim 13, wherein the driver circuit comprises:
a reference generator configured to produce a triangle wave;
a sensing circuit coupled to the MEMS mirror and configured to produce a measurement signal indicating an angle of rotation of the mirror; and
control circuitry operable to generate a drive signal for the MEMS mirror from a difference between the triangle wave and the measurement signal.

16. An NUI system, comprising:
a LADAR module; and
a computer system coupled to receive from the LADAR module, spatial measurements of an environment including a user, wherein the computer system contains a module that when executed interprets the spatial measurements to identify instructions from the user for control of the computer system.

17. The system of claim 16, wherein the LADAR module comprises:
a scanning system containing a mirror mounted for oscillations about a first axis and about a second axis; and
a driver circuit adapted to drive the mirror for continuous oscillation providing scanning about the first axis at a first frequency and about the second axis at a second frequency that is lower than the first frequency.

18. The system of claim 17, wherein the driver circuit and the scanning mirror operate to provide a scan beam with a triangular trajectory for scanning about the first axis.
